(19) United States
(12) Patent Application Publication
(10) Pub. No.: US 2012/0063720 A1
(43) Pub. Date: Mar. 15, 2012

(54) OPTICAL FIBER ASSEMBLY AND METHODS OF MAKING THE SAME

(75) Inventors: Baishi Wang, Princeton, NJ (US); Mathieu Alexandre Antoina, Rueil Malmaison (FR); Ying Qin, Morganville, NJ (US)

(73) Assignee: VYTRAN, LLC, Morganville, NJ (US)

(21) Appl. No.: 13/228,202

(22) Filed: Sep. 8, 2011

Related U.S. Application Data
(60) Provisional application No. 61/380,927, filed on Sep. 8, 2010.

(51) Int. Cl. G02B 6/255; G02B 6/32

(52) U.S. Cl. 385/28; 65/407; 65/387

(57) ABSTRACT

In some embodiments, an optical fiber assembly apparatus includes a signal fiber having a substantially constant outer diameter, a proximal portion, and a distal portion. The proximal portion has a waveguide structure configured to propagate an optical signal having a first mode field diameter and the distal portion has a waveguide structure configured to propagate the optical signal having the first mode field diameter at a proximal end of the distal portion and has an expanded waveguide structure configured to propagate the optical signal having a second mode field diameter at a distal end of the distal portion. The optical fiber assembly includes a lens fiber having a proximal end. The proximal end of the lens fiber is fused to the distal end of the distal portion of the signal fiber. The lens fiber is configured to propagate an optical signal through a nominally homogenous region.

### RELATED APPLICATIONS

This application claims priority to U.S. Provisional Application No. 61/380,927 filed Sep. 8, 2010, and entitled “OPTICAL FIBER WITH END-CAP LENS AND METHOD FOR MAKING THE SAME,” the contents of which are herein incorporated by reference in its entirety.

### BACKGROUND

Some embodiments described herein relate generally to optical fiber assemblies and methods of making the same.

Known devices exist for coupling collimated free space beams. Such known devices can have strict mechanical tolerances, which can result in high loss and inefficient coupling. This can further result in undesirable variability in coupling. Known devices are particularly inefficient at coupling single mode optical fibers transmitting visible wavelength signals having small mode field diameters.

Accordingly, a need exists for an improved optical fiber assembly and method for making optical fiber assemblies.

### SUMMARY

In some embodiments, an optical fiber assembly apparatus includes a signal fiber having a substantially constant outer diameter, a proximal portion, and a distal portion. The proximal portion has a waveguide structure configured to propagate an optical signal having a first mode field diameter and the distal portion has an expanded waveguide structure configured to propagate the optical signal having the first mode field diameter at a proximal end of the distal portion and propagate the optical signal having a second mode field diameter at a distal end of the distal portion. The optical fiber assembly includes a lens fiber having a proximal end. The proximal end of the lens fiber is fused to the distal end of the distal portion of the signal fiber. The lens fiber is configured to propagate an optical signal through a nominally homogenous region.

### BRIEF DESCRIPTION OF THE DRAWINGS

FIG. 1 is a block diagram of an optical fiber assembly according to an embodiment.

FIG. 2 is a schematic illustration of an optical fiber assembly according to an embodiment.

FIG. 3 is a schematic illustration of a first optical fiber assembly shown in FIG. 2 transmitting a signal to a second optical fiber assembly shown in FIG. 2.

FIG. 4 is a flow chart showing a method of making an optical fiber assembly according to an embodiment.

FIG. 5 is a schematic illustration showing a method of making an optical fiber assembly according to an embodiment.

FIG. 6 is a schematic illustration showing a method of making an optical fiber assembly according to an embodiment.

FIG. 7 is a schematic illustration of an optical fiber assembly according to an embodiment.

FIG. 8 is a schematic illustration of an optical fiber assembly according to an embodiment.

FIG. 9 is a schematic illustration of an optical fiber assembly according to an embodiment.

FIG. 10 is a schematic illustration of an optical fiber assembly according to an embodiment.

### DETAILED DESCRIPTION

In some embodiments, an optical fiber assembly apparatus includes a signal fiber having a substantially constant outer diameter, a proximal portion, and a distal portion. The proximal portion has a waveguide structure configured to propagate an optical signal having a first mode field diameter and the distal portion has an expanded waveguide structure configured to propagate the optical signal having the first mode field diameter at a proximal end of the distal portion and propagate the optical signal having a second mode field diameter at a distal end of the distal portion. The optical fiber assembly includes a lens fiber having a proximal end. The proximal end of the lens fiber is fused to the distal end of the distal portion of the signal fiber. The lens fiber is configured to propagate an optical signal through a nominally homogenous region.

In some embodiments, an apparatus includes an optical fiber assembly including a signal fiber having a substantially constant outer diameter. The signal fiber has a mode expansion region configured to expand a mode field diameter of a signal from a first mode field diameter to a second mode field diameter. The optical fiber assembly includes an intermediate optical fiber. A proximal end of the intermediate optical fiber has a first outer diameter and is fused to a distal end of the signal fiber. A distal end of the intermediate optical fiber has a second outer diameter. The optical fiber assembly includes a lens fiber having a substantially constant outer diameter, and the lens fiber is fused to the distal end of the intermediate optical fiber.

In some embodiments, a method includes heating a distal portion of a signal fiber to define a mode expansion region configured to expand a mode field diameter of an optical signal from a first mode field diameter to a second mode field diameter. The method includes fusing a proximal end of a lens fiber to a distal end of the signal fiber.

As used in this specification, the singular forms “a,” “an” and “the” include plural referents unless the context clearly dictates otherwise. Thus, for example, the term “a tapered fiber” is intended to mean a single tapered fiber or a combination of tapered fibers. As used in this specification, “monolithically formed” can mean that some or all of the optical components are formed from a common material. As used herein, “integrally formed” can mean some or all of the optical components are formed from different materials and are fixedly or permanently attached, coupled, fused or bonded together (e.g., spliced together).

In some embodiments described herein, an optical fiber assembly can be used to transmit power, data, sensor signals or any combinations of these signals. In some embodiments, the optical fiber assembly can be an “all-fiber” device, e.g., a device wherein all of the signal carrying components of the optical fiber assembly include glass, such as, for example, silica glass, phosphate glass, germanium glass, etc. In some embodiments, some or all of the optical components of the all-fiber device, such as the signal fiber, lens fiber, etc. can be monolithically formed or integrally formed. In some embodiments, the all-fiber device can be formed from a combination of one or more monolithically-formed optical components and one or more integrally formed optical components. The optical fiber assembly can be robust, inexpensive, reduce or eliminate mechanical misalignment, allow better control of mode field diameter size, accommodate a large free-space beam, and can have high coupling efficiency.

An optical fiber, such as, for example, a signal fiber, an intermediate fiber, a tapered fiber, a lens fiber, and/or portions thereof, can define a mode field diameter of a signal propagated through that optical fiber. In some embodiments, a waveguide structure, for example, an optical fiber having a core and cladding, can define the mode field diameter of the signal. In such embodiments, the optical fiber can substantially confine the signal to the core. Said another way, the waveguide structure can substantially prevent diffraction from expanding a mode field diameter of the signal. The mode field diameter of a signal can be characterized and/or represented by a mode profile. Said another way, an optical fiber can support a mode profile. A mode profile can be generally Gaussian and the characteristics of the Gaussian shape can depend on, for example, the mode field diameter of a signal propagating through the optical fiber. By way of example, a signal having a first mode field diameter can propagate through a first optical fiber having a first mode profile. The signal can pass into a second optical fiber supporting the first mode profile at a proximal end and supporting a second mode profile at a distal end. In this example, the mode field diameter of the signal can expand from the first mode field diameter to a second mode field diameter. In some such embodiments, the first optical fiber and the second optical fiber can be chosen such that the mode field diameter of the signal can expand from the first mode field diameter to the second mode field diameter adiabatically to reduce signal loss.

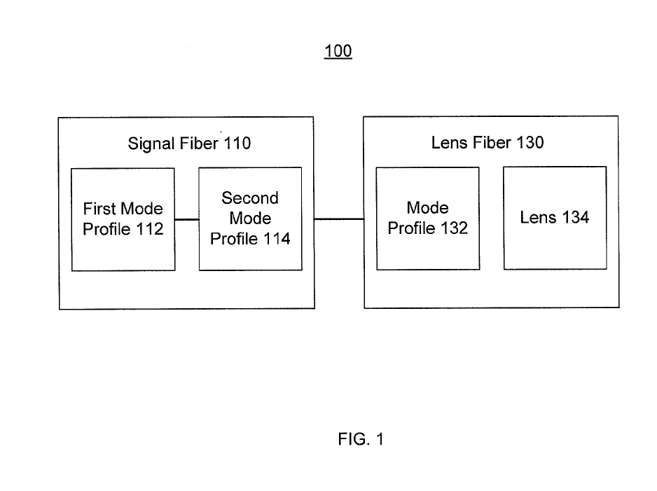

FIG. 1 depicts a block diagram of an optical fiber assembly 100. Optical fiber assembly 100 includes a signal fiber 110 configured to be coupled to a lens fiber 130. Signal fiber 110 supports a first mode profile 112 and supports a second mode profile 114. Lens fiber 130 supports a mode profile 132 and includes a lens 134.

Signal fiber 110 can include a waveguide structure (not shown) defining a core (not shown), and can include a proximal portion (not shown in FIG. 1) supporting first mode profile 112, and a distal portion (not shown in FIG. 1) supporting second mode profile 114. Signal fiber 110 can be configured to propagate a single mode signal. In some embodiments, the single mode signal can be transmitted in a visible wavelength, such as, for example, between about 400 nanometers and about 700 nanometers. In some embodiments, signal fiber 110 can have a substantially constant outer diameter (not shown in FIG. 1). In some embodiments, the substantially constant outer diameter can be about 125 microns. In other embodiments, the substantially outer diameter can be larger or smaller. The substantially constant outer diameter can be larger than a mode field diameter of a signal. In some embodiments, the waveguide structure of the proximal portion of the signal fiber 110 and the waveguide structure of the distal portion of the signal fiber 110 can be substantially the same, e.g. uniform throughout. In this manner, first mode profile 112 and second mode profile 114 can be substantially the same. In some embodiments, the distal portion of signal fiber 110 can be altered, such as, for example, by applying heat to the distal portion of the signal fiber 100, such that the waveguide structure of the distal portion of signal portion 110 is altered. Altering can include, for example, causing diffusion of dopants in signal fiber 110. In such embodiments, first mode profile 112 can be different from second mode profile 114. In these embodiments, the first mode profile 112 can be such that the mode field diameter of the signal is constant through the first portion of signal fiber 110, and, because second mode profile 114 is different than first mode profile 112, the mode field diameter of the signal can expand along the distal portion of signal fiber 110. In such embodiments, the expansion of the mode field diameter is adiabatically tapered.

When a monolithically formed signal fiber 110 having a constant outer diameter supports a second mode profile for the distal portion, different from a first mode profile supported by the proximal portion, the distal portion of the signal fiber 110 can be referred to as a mode expansion region. The length of the mode expansion region can vary. In some embodiments, the length of the mode expansion region can be about one millimeter. In other embodiments, the length of the mode expansion region can be between about 100 microns and about ten millimeters. The mode expansion region can expand the mode field diameter of the signal for an amount between about ten percent expansion and about 400 percent expansion. The amount of expansion of the mode field diameter of the signal through the mode expansion region can be based on, for example, the length of the mode expansion region, characteristics of the waveguide structure of the signal fiber 110, how the distal portion of the signal fiber 110 was altered, the outer diameter of the signal fiber, and/or combinations of the above.

Lens fiber 130 can include a coreless structure, e.g., may not have a waveguide structure to reduce or prevent diffraction. In this manner, lens fiber 130 can include a nominally homogenous refractive index. Lens fiber 130 supports mode profile 132 at a distal end and includes lens 134. In some embodiments, the coreless structure of lens fiber 130 can allow the mode field diameter of a signal to expand by diffraction. In this manner, the mode field diameter of the signal can increase along a length of lens fiber 130. Lens 134 of lens fiber 130 can be curved to collimate the signal light exiting lens fiber 130. In some embodiments, lens 134 can be curved such that the signal mode field diameter increases, decreases, or is collimated as it propagates away from the lens fiber, e.g., to expand or to reduce the signal mode field diameter. In such embodiments, increasing the radius of curvature of the lens can increase the mode field diameter of the signal as it propagates away from the lens fiber, and decreasing the radius of curvature can reduce the mode field diameter of the signal as it propagates away from the lens fiber.

Lens fiber 130 can have a substantially constant outer diameter. In some embodiments, the substantially constant outer diameter of lens fiber 130 can be larger than the substantially constant outer diameter of signal fiber 110. In such embodiments, the substantially constant outer diameter of the lens fibers can be, for example, less than about three times as large as the substantially constant outer diameter of signal fiber 110. In this manner, lens fibers 130 can be more easily spliced/fused to signal fiber 110, and the splice/fuse can be stronger, e.g., less likely to fail. In some embodiments, the substantially constant outer diameter of lens fiber 130 can be larger or smaller than three times the substantially constant outer diameter of signal fiber 110. In some embodiments, the outer diameter of lens fiber 130 can be at least twice the size of the mode field diameter. In such embodiments, the outer diameter of the lens fiber 130 can be at least three times the size of the mode field diameter. Lens fiber 130 can include a waveguide structure (not shown) defining a core (not shown). A diameter of the core can be, for example, larger than the mode field diameter of the signal at any point within lens fiber 130. In such embodiments, the core of lens fiber 130 may not prevent the expansion of the mode field diameter of a signal passing through lens fiber 130.

In one example, a single mode signal can have about a four micron mode field diameter for the visible range centered around 630 nanometers. The signal can enter the distal portion of signal fiber 110 and can propagate through the mode expansion region; the mode field diameter of the signal can expand from about four microns to about five microns. The signal can enter lens fiber 130, which has a length of about two millimeters, and the mode field diameter of the signal can expand from about five microns to about 0.22 millimeters. The signal can exit lens fiber 130 via lens 134 as a collimated beam with a substantially constant outer diameter of about 0.22 millimeters. In some other embodiments, lens fiber 130 can be about one millimeter long and the signal can exit lens fiber 130 via lens 134 as a collimated beam with a substantially constant outer diameter of about 0.11 millimeters. In yet other embodiments, lens fiber 130 can be about four millimeters long and the signal can exit lens fiber 130 via lens 134 as a collimated beam with a substantially constant outer diameter of about 0.44 millimeters.

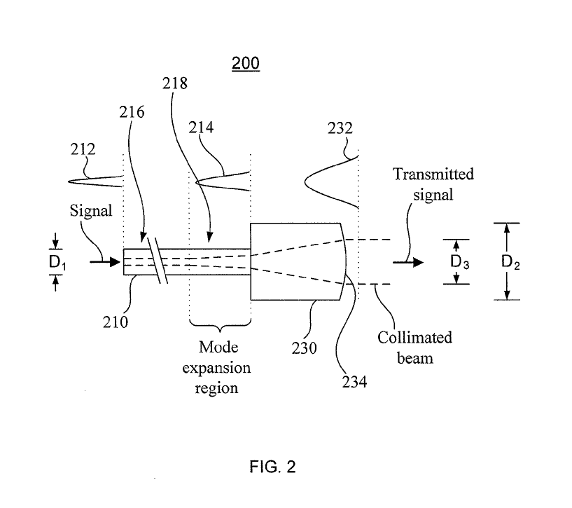

FIG. 2 is a schematic view of an optical fiber assembly 200. Optical fiber assembly 200 can be similar to optical fiber assembly 100 and can include similar components. For example, optical fiber assembly 200 can include a signal fiber 210 similar to signal fiber 110 of optical fiber assembly 100. Optical fiber assembly 200 includes signal fiber 210 configured to be coupled to a lens fiber 230. Signal fiber 210 includes a proximal portion 216 that supports a mode profile 212, and a distal portion 218 that supports second mode profile 214 at a distal end of distal end portion 218. Lens fiber 230 includes a lens 234 at a distal end, and supports a mode profile 232 at the distal end.

Signal fiber 210 can include a waveguide structure (not shown) defining a core (not shown). Signal fiber 210 can be configured to propagate a single mode signal. In some embodiments, the single mode signal can be transmitted about a center wavelength in the visible spectrum, such as, for example, between about 400 nanometers and about 700 nanometers. In some embodiments, signal fiber 210 can have a substantially constant outer diameter D₁. In some embodiments, the substantially constant outer diameter D₁ can be about 125 microns. In other embodiments, the substantially constant outer diameter D₁ can be larger or smaller. The substantially constant outer diameter can be larger than a mode field diameter of a signal passing through signal fiber 210. The waveguide structure of distal portion 218 of signal fiber 210 is altered, for example, by applying heat to distal portion 218 of the signal fiber 200, such that the waveguide structure of distal portion 218 of signal fiber 210 is altered. Altering can include, for example, causing diffusion of dopants in signal fiber 210. In such embodiments, first mode profile 212 can be different from second mode profile 214. The first mode profile 212 can be such that the mode field diameter of the signal is constant through proximal portion 216 of signal fiber 200. Second mode profile 214 can be such that the mode field diameter increases along distal portion 218 of signal fiber 210. In such embodiments, the increase in mode field diameter can be adiabatically tapered so that transmission losses associated with the transformation of the mode profile are negligible.

Distal portion 218 of signal fiber 210 includes a mode expansion region. The length of the mode expansion region can vary. In some embodiments, the length of the mode expansion region can be about one millimeter. In other embodiments, the length of the mode expansion region can be between about 100 microns and about ten millimeters. The mode expansion region can expand the mode field diameter of a signal for an amount between about ten percent expansion and about 400 percent expansion. The amount of expansion of the mode field diameter through the mode expansion region can be based on, for example, the length of the mode expansion region, characteristics of the waveguide structure of the signal fiber 210, how the distal portion of the signal fiber was altered, the substantially constant outer diameter D₁ of the signal fiber, and/or combinations of the above.

Lens fiber 230 can include a coreless structure, e.g., may not have a waveguide structure to reduce or prevent diffraction. In this manner, lens fiber 230 can include a nominally homogenous refractive index. Lens fiber 230 supports mode profile 232 and includes lens 234. In some embodiments, the coreless structure of lens fiber 230 can allow the mode field diameter of a signal to expand by diffraction. In this manner, the mode field diameter of the signal can increase along a length of lens fiber 230. Lens 234 of lens fiber 230 can be curved to collimate the signal light exiting lens fiber 230. In some embodiments, lens 234 can be curved such that the signal mode field diameter increases, decreases, or is collimated as it propagates away from the lens fiber 230, e.g., to expand or to reduce the signal mode field diameter. In such embodiments, increasing the radius of curvature of lens 234 can increase the mode field diameter of the signal as it propagates away from lens fiber 230, and decreasing the radius of curvature can reduce the mode field diameter of the signal as it propagates away from the lens fiber.

Lens fiber 230 includes a substantially constant outer diameter D₂. In some embodiments, the substantially constant outer diameter D₂ of lens fiber 230 can be larger than the substantially constant outer diameter D₁ of signal fiber 210. In such embodiments, the substantially constant outer diameter D₂ of the lens fibers can be, for example, less than about three times as large as the substantially constant outer diameter D₁ of signal fiber 210. In this manner, lens fibers 230 can be more easily spliced/fused to signal fiber 210, and the splice/fuse can be stronger, e.g., less likely to fail. In some embodiments the substantially constant outer diameter D₂ of lens fiber 230 can be larger or smaller than three times the substantially constant outer diameter D₁ of signal fiber 210. In some embodiments, the outer diameter of lens fiber 230 can be at least twice the size of the mode field diameter of the signal. In such embodiments, the outer diameter of the lens fiber 230 can be at least three times the size of the mode field diameter of the signal. While shown in FIG. 2 as including a substantially constant outer diameter, in some embodiments, Lens fiber 230 can have a changing outer diameter, such as, for example, a tapering diameter. In some embodiments, lens fiber 230 can include a waveguide structure (not shown) defining a core (not shown). In such embodiments, a diameter of the core can be larger than the mode field diameter of the signal at any point within lens fiber 230. In such embodiments, the core of lens fiber 230 may not prevent the expansion of the mode field diameter of a signal passing through lens fiber 230.

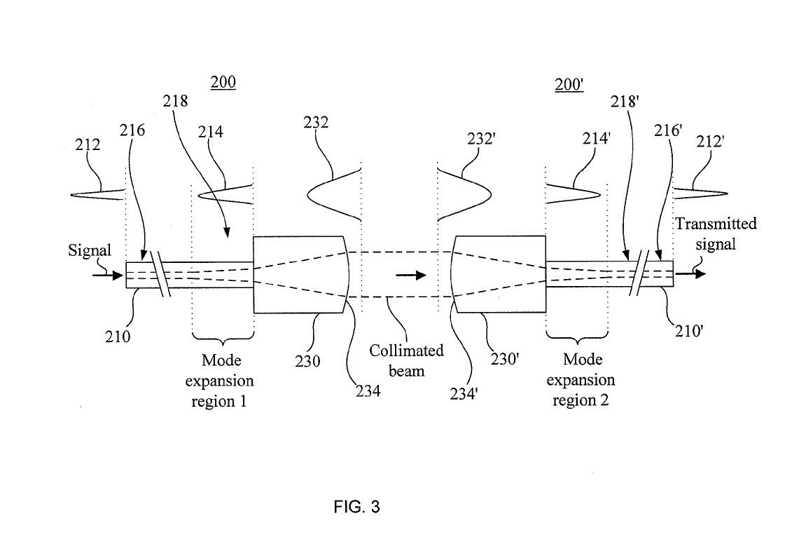

FIG. 3 is a schematic illustration of a first optical fiber assembly 200 transmitting a signal to a second optical fiber assembly 200′. As shown in FIG. 3, a signal can enter proximal portion 216 of signal fiber 210. Proximal portion 216 of optical fiber assembly 200 supports first mode profile 212. The signal can propagate through the proximal portion 216 with a substantially constant mode field diameter. Distal end of distal portion 218 (also the mode expansion region) of signal fiber 210, supports second mode profile 218, and as the signal propagates from the proximal end of distal portion 218 to the distal end of distal portion 218, the mode field diameter of the signal can expand from the first mode field diameter to a second mode field diameter, larger than the first mode field diameter. The signal can propagate into lens fiber 230 and the mode profile of the signal can expand from the second mode profile 218 to a third mode profile 232, larger than the second mode profile 218. The third mode profile 232 is a at least partially characterized by third mode field diameter that is larger than the second mode field diameter. Lens 234 can collimate the signal such that the signal travels through free space as a collimated beam having a substantially constant outer diameter D₃. The collimated signal beam can propagate through free space for relatively short distances with a substantially constant mode field diameter. The signal can enter lens 234′ of lens fiber 230′ of optical fiber assembly 200′ and the signal can have the third mode field diameter, characterized by mode profile 232′, which is substantially equal to the mode profile 232. As the signal travels through lens fiber 230′, the mode field diameter of the signal can reduce from the third mode field diameter to the second mode field diameter as represented by mode profile 214″. The signal can travel into distal portion 218′ (also a mode expansion region, in this case used as a mode reduction region) of signal fiber 210′, and the mode field diameter of the signal can reduce from the second mode field diameter to the first mode field diameter as represented by mode profile 212′. The signal can enter proximal portion 216′ of signal fiber 210′ which transmits the signal with a substantially constant mode profile 212′ at least partially characterized by the first mode field diameter.

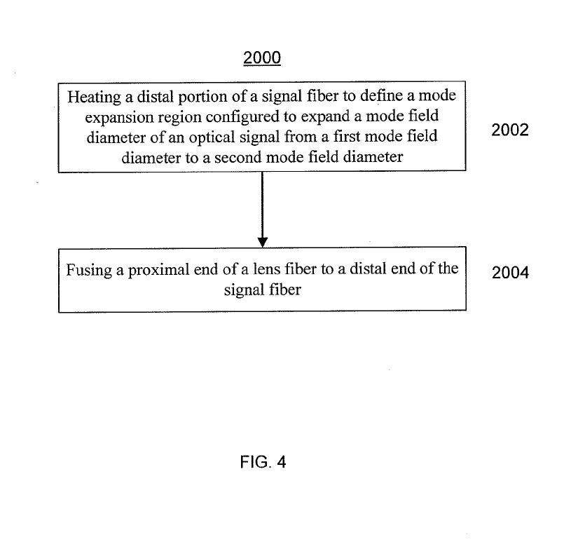

FIG. 4 is a flow chart showing a method 2000 of making an optical fiber assembly. Method 2000 includes heating a distal portion of a signal fiber to define a mode expansion region that is configured such that a signal propagating through the mode expansion region can have a mode field diameter vary from a first mode field diameter to a second mode field diameter, at 2002. In some embodiments, the heat source can be, for example, a heated filament. The temperature of the heat source, the length of the distal portion heated, and the amount of time the distal portion is heated can be based on characteristics of the signal fiber, characteristics of a lens fiber of the optical fiber assembly, characteristics of the signal, characteristics of a collimated free-space beam, and/or combinations of the above. Method 2000 includes fusing a proximal end of the lens fiber to a distal end of the signal fiber, the lens fiber is configured such that a signal propagating through the mode expansion region can have a mode field diameter vary from the second mode diameter to a third mode field diameter, different from the second mode field diameter, at 2004. In some embodiments, the lens fiber can be fused to the signal fiber with a heated filament. In some embodiments, method 2000 can be performed using a fusion/splicer apparatus.

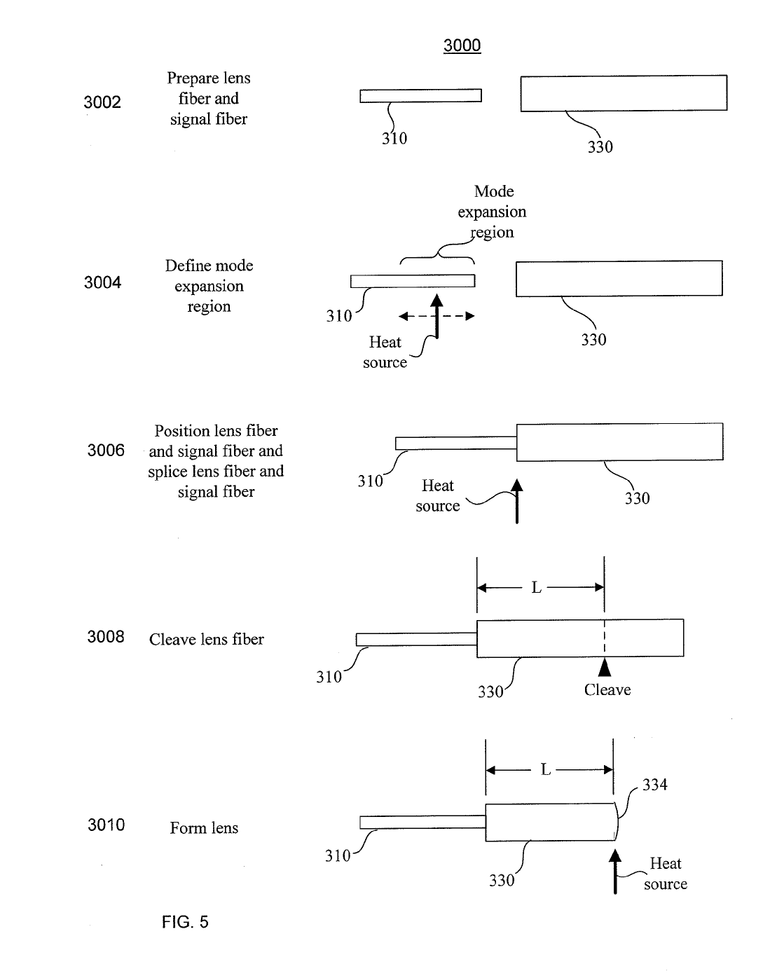

FIG. 5 is a schematic illustration of a method 3000 of making an optical fiber assembly. Method 3000 includes preparing a lens fiber 330 and a signal fiber 310, at 3002. Preparing lens fiber 330 and signal fiber 310 can include, for example, positioning the lens fiber 330 and the signal fiber 310 for fusing/splicing, such as, for example, ensuring that the distal end of the signal fiber 310 and proximal end of the lens fiber 330 are substantially flat and parallel to each other, cleaning the signal fiber 310 and the lens fiber 330, and/or ensuring any coating is removed. Other example of preparing the lens fiber 330 and/or the signal fiber 310 can include treating the lens fiber 330 and/or the signal fiber 310 with a chemical substance configured to improve or strengthen a fuse/splice. Method 3000 includes defining a mode expansion region in a portion of signal fiber 310, at 3004. Defining the mode expansion region can include heating that portion of signal fiber 310 with a heat source. The temperature of the heat source, the length of the portion of signal fiber 310 to be heated, and the amount of time the portion of signal fiber 310 is heated can be based on characteristics of signal fiber 310, characteristics of lens fiber 330, characteristics of a signal, characteristics of a free-space beam, and/or combinations of the above. Method 3000 includes positioning lens fiber 330 and signal fiber 310, and splicing lens fiber 330 and signal fiber 310, at 3006. Method 3000 can include cleaving a portion of lens fiber 330, at 3008. Said another way a portion of lens fiber 330 can be removed. Method 3000 includes forming a lens 334 of lens fiber 330, at 3010. Forming lens 334 can include melting a distal end of lens fiber 330 so that surface tension causes the distal end to round to a predetermined curvature. Alternatively, forming lens 334 can include polishing a distal end of lens fiber 330 to a predetermined curvature. The curvature can be determined based on characteristics of signal fiber 310, characteristics of the mode expansion region, characteristics of lens fiber 330, characteristics of a signal, characteristics of a free-space beam, and/or combinations of the above. In some embodiments, method 3000 can be performed using a fusion/splicer apparatus.

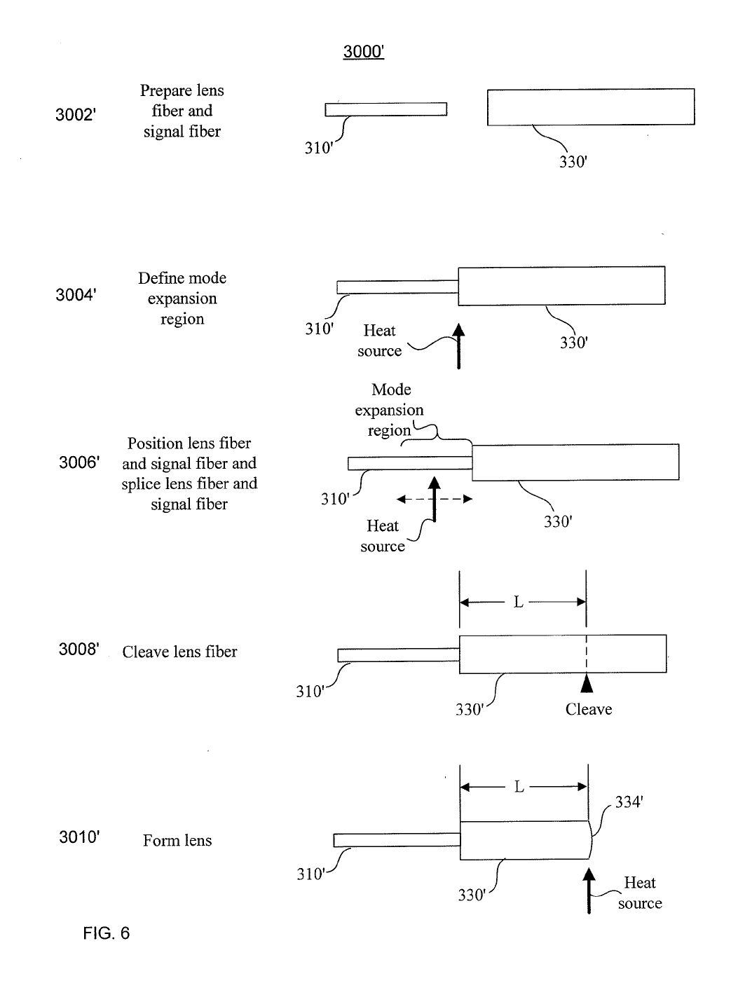

FIG. 6 is a schematic illustration of a method 3000′ of making an optical fiber assembly. Method 3000′ includes preparing a lens fiber 330′ and a signal fiber 310′, at 3002′. Preparing lens fiber 330′ and signal fiber 310′ can include, for example, preparing the lens fiber 330′ and the lens fiber 310′ for fusing/splicing, such as, for example, ensuring that the distal end of the signal fiber 310 and proximal end of the lens fiber 330 are substantially flat and parallel to each other, cleaning the signal fiber 310′ and the lens fiber 330′, and/or ensuring any coating is removed. Method 3000′ includes positioning lens fiber 330′ and signal fiber 310′, and splicing lens fiber 330′ and signal fiber 310′, at 3004′. Method 3000′ includes defining a mode expansion region in a portion of signal fiber 310′, at 3006′. Defining the mode expansion region can include heating that portion of signal fiber 310′ with a heat source. The temperature of the heat source, the length of the portion of signal fiber 310′ to be heated, and the amount of time the portion of signal fiber 310′ is heated can be based on characteristics of signal fiber 310′, characteristics of lens fiber 330′, characteristics of a signal, characteristics of a free-space beam, and/or combinations of the above. Method 3000′ can include cleaving a portion of lens fiber 330′, at 3008′. Said another way, a portion of lens fiber 330′ can be removed. Method 3000′ includes forming a lens 334′ of lens fiber 330′, at 3010′. Forming lens 334′ can include melting a distal end of lens fiber 330′ so that surface tension causes the distal end to round to a predetermined curvature. Alternatively, forming lens 334′ can include polishing a distal end of lens fiber 330′ to a predetermined curvature. The curvature can be determined based on characteristics of signal fiber 310′, characteristics of lens fiber 330′, characteristics of a signal, characteristics of a free-space beam, and/or combinations of the above. In some embodiments, method 3000 can be performed using a fusion/splicer apparatus.

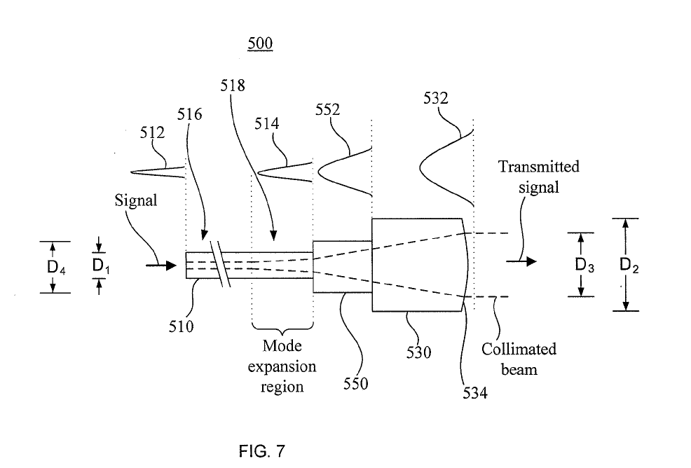

FIGS. 7-10 depict optical fiber assemblies including intermediate optical fibers, such as, for example, tapered intermediate fibers (“tapered fibers”) and/or non-tapered intermediate fibers (“intermediate fibers”) in addition to a signal fiber and a lens fiber. Such embodiments can allow larger degrees of mode expansion between a signal fiber and a lens, can minimize difference in optical fiber outer diameter sizes, and can allow a flexible architecture for connecting optical fibers of different sizes, and/or optical fibers transmitting signals having different characteristics.

FIG. 7 is a schematic illustration of an optical fiber assembly 500. Optical fiber assembly 500 can be similar to optical fiber assemblies 100, 200 and can include similar components. For example, optical fiber assembly 500 can include a signal fiber 510 similar to signal fibers 110, 210 of optical fiber assemblies 100, 200. Signal fiber 510 supports a first mode profile 512 and supports a second mode profile 514. Unlike optical fiber assembly 200, optical fiber assembly 500 includes an intermediate fiber 550 disposed between signal fiber 510 and lens fiber 530. Lens fiber 530 includes a lens 534.

Intermediate fiber 550 can include a coreless structure, e.g., may not have a waveguide structure to reduce or prevent diffraction. In this manner, intermediate fiber 550 is represented by a nominally homogenous refractive index. Intermediate fiber 550 can support mode profile 552 at a distal end. In some embodiments, the coreless structure of intermediate fiber 550 can allow the mode field diameter of a signal to expand by diffraction. In this manner, mode profile 552 can be such that the mode field diameter of the signal can increase along the intermediate fiber 550 (in the direction of the signal shown in FIG. 7). In some embodiments, intermediate fiber 550 can include a waveguide structure (not shown) defining a core (not shown). In such embodiments, a diameter of the core can be larger than the mode field diameter of the signal at any point within intermediate fiber 550. In such embodiments, the core of intermediate fiber 550 may not prevent the expansion of the mode field diameter of a signal passing through intermediate fiber 550.

Intermediate fiber 550 includes a substantially constant outer diameter D₄. In some embodiments, the substantially constant outer diameter D₄ of intermediate fiber 550 can be larger than the substantially constant outer diameter D₁ of signal fiber 510. In such embodiments, the substantially constant outer diameter D₄ of the intermediate fiber can be less than about three times as large as the substantially constant outer diameter D₁ of signal fiber 510. In this manner, intermediate fiber 550 can be more easily spliced/fused to signal fiber 510, and the splice/fuse can be stronger, e.g., less likely to fail. In some embodiments the substantially constant outer diameter D₄ of intermediate fiber 550 can be larger or smaller than three times the substantially constant outer diameter D₁ of signal fiber 510.

Lens fiber 530 includes a substantially constant outer diameter D₂. In some embodiments, the substantially constant outer diameter D₂ of lens fiber 530 can be larger than the substantially constant outer diameter D₄ of intermediate fiber 550. In such embodiments, the substantially constant outer diameter D₂ of the lens fibers can be less than about three times as large as the substantially constant outer diameter D₄ of intermediate fiber 550. In this manner, lens fibers 530 can be more easily spliced/fused to intermediate fiber 550, and the splice/fuse can be stronger, e.g., less likely to fail. In some embodiments the substantially constant outer diameter D₂ of lens fiber 530 can be larger or smaller than three times the substantially constant outer diameter D₄ of intermediate fiber 550.

A signal propagating through optical fiber assembly 500 can have a first mode field diameter in a proximal portion 516 of signal fiber 510, represented by first mode profile 512. The signal can have a mode field diameter expanding from the first mode field diameter to a second mode field diameter in distal portion 518 of signal fiber 510, represented by second mode profile 514. The signal can have a mode field diameter expanding from the second mode field diameter to a third mode field diameter in intermediate fiber 550, represented by mode profile 552. The signal can have a mode field diameter expanding from the third mode field diameter to a fourth mode field diameter in lens fiber 530, represented by mode profile 532. Lens 534 can collimate the signal into a collimated beam propagating in free space with a substantially constant outer diameter D₃.

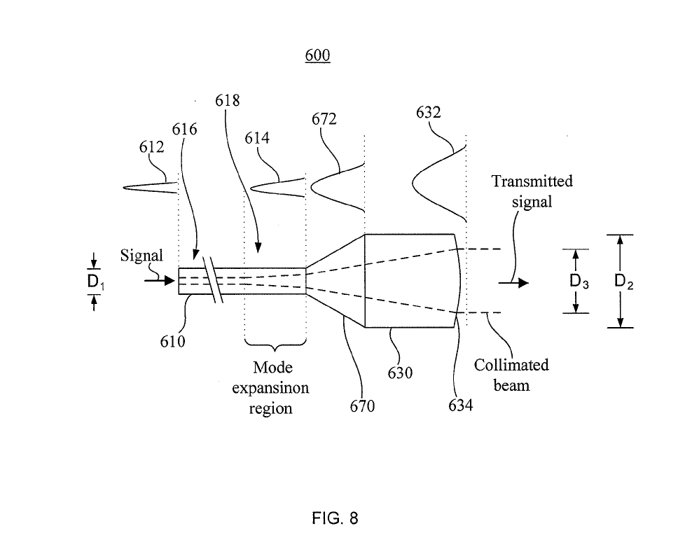

FIG. 8 is a schematic illustration of an optical fiber assembly 600. Optical fiber assembly 600 can be similar to optical fiber assemblies 100, 200 and can include similar components. For example, optical fiber assembly 600 can include a signal fiber 610 similar to signal fibers 110, 210 of optical fiber assemblies 100, 200. Signal fiber 610 supports a first mode profile 612 and supports a second mode profile 614. Lens fiber 630 includes a lens 634 and supports a mode profile 632. Unlike optical fiber assembly 200, optical fiber assembly 600 includes a tapered fiber 670 disposed between signal fiber 610 and lens fiber 630.

Tapered fiber 670 can include a coreless structure, e.g., may not have a waveguide structure to reduce or prevent diffraction. In this manner, tapered fiber 670 can include a nominally homogenous refractive index. Tapered fiber 670 can support mode profile 672 at a distal end. In some embodiments, the coreless structure of tapered fiber 670 can allow the mode field diameter of a signal to expand by diffraction. In this manner, mode profile 672 can represent an expanding mode profile corresponding to the mode field diameter of the signal increasing along the tapered fiber 670. In some embodiments, tapered fiber 670 can include a waveguide structure (not shown) defining a core (not shown). In such embodiments, a diameter of the core can be larger than the mode field diameter of the signal at any point within tapered fiber 670. In such embodiments, the core of tapered fiber 670 may not prevent the expansion of the mode field diameter of a signal passing through tapered fiber 670.

Tapered fiber 670 includes a tapered outer diameter. The tapered outer diameter of tapered fiber can increase from a first outer diameter D₁ to second outer diameter D₂. In some embodiments, the first outer diameter D₁ of tapered fiber 670 can be substantially the same as the substantially constant outer diameter D₁ of signal fiber 610. In this manner, tapered fiber 670 can be more easily spliced/fused to signal fiber 610, and the splice/fuse can be stronger, e.g., less likely to fail. In some embodiments the first outer diameter of tapered fiber 670 can be larger or smaller than the substantially constant outer diameter D₁ of signal fiber 610.

Lens fiber 630 includes a substantially constant outer diameter D₂. In some embodiments, the substantially constant outer diameter D₂ of lens fiber 630 can be substantially the same as the second outer diameter D₂ of tapered fiber 670. In this manner, lens fibers 630 can be more easily spliced/fused to tapered fiber 670, and the splice/fuse can be stronger, e.g., less likely to fail. In some embodiments the substantially constant outer diameter D₂ of lens fiber 630 can be larger or smaller than the second outer diameter of tapered fiber 670.

A signal propagating through optical fiber assembly 600 can have a first mode field diameter in a proximal portion 616 of signal fiber 610, represented by first mode profile 612. The signal can have a mode field diameter expanding from the first mode field diameter to a second mode field diameter in distal portion 618 of signal fiber 610, represented by second mode profile 614. The signal can have a mode field diameter expanding from the second mode field diameter to a third mode field diameter in tapered fiber 670, represented by mode profile 672. The signal can have a mode field diameter expanding from the third mode field diameter to a fourth mode field diameter in lens fiber 630, represented by mode profile 632. Lens 634 can collimate the signal into a collimated beam propagating in free space with a substantially constant outer diameter D₃.

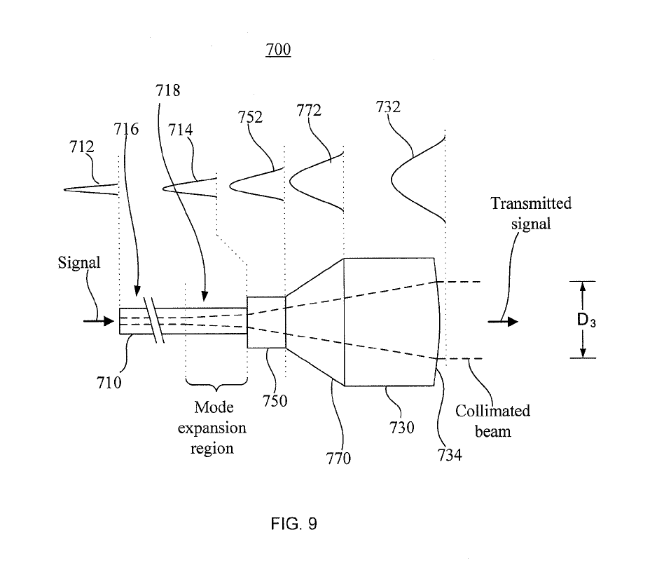

FIG. 9 is a schematic illustration of an optical fiber assembly 700. Optical fiber assembly 700 can be similar to optical fiber assemblies 100, 200 and can include similar components. For example, optical fiber assembly 700 can include a signal fiber 710 similar to signal fibers 110, 210 of optical fiber assemblies 100, 200. Signal fiber 710 supports a first mode profile 712 and supports a second mode profile 714. Lens fiber 730 includes a lens 734 and supports a mode profile 732 at a distal end. Unlike optical fiber assembly 200, optical fiber assembly 700 includes both an intermediate fiber 750 similar to intermediate fiber 550 of optical fiber assembly 500, and a tapered fiber 770 similar to tapered fiber 670 of optical fiber assembly 600. Intermediate fiber 750 is disposed between signal fiber 710 and tapered fiber 770, and tapered fiber 770 is disposed between intermediate fiber 750 and lens fiber 730.

A signal traveling through optical fiber assembly 700 can have a first mode field diameter in a proximal portion 716 of signal fiber 710, as represented by first mode profile 712. The signal can have a mode field diameter expanding from the first mode field diameter to a second mode field diameter in distal portion 718 of signal fiber 710, as represented by second mode profile 714. The signal can have a mode field diameter expanding from the second mode field diameter to a third mode field diameter in intermediate fiber 750, as represented by mode profile 752. The signal can have a mode field diameter expanding from the third mode field diameter to a fourth mode field diameter in tapered fiber 770, as represented by mode profile 772. The signal can have a mode field diameter expanding from the fourth mode field diameter to a fifth mode field diameter in lens fiber 730, as represented by mode profile 732. Lens 734 can collimate the signal into a collimated beam propagating in free space with a substantially constant outer diameter D₃.

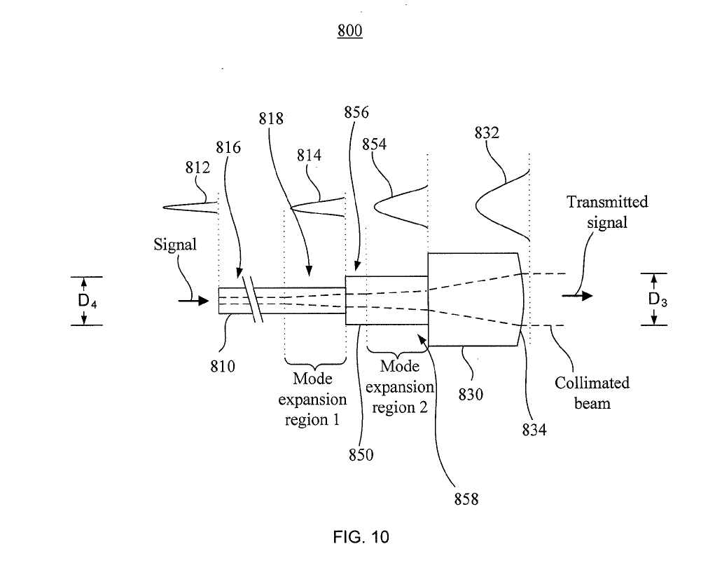

FIG. 10 is a schematic illustration of an optical fiber assembly 800. Optical fiber assembly 800 can be similar to optical fiber assemblies 100, 200 and can include similar components. For example, optical fiber assembly 800 can include a signal fiber 810 similar to signal fibers 110, 210 of optical fiber assemblies 100, 200. Signal fiber 810 is configured to be coupled to a lens fiber 830. Signal fiber 810 is supports a first mode profile 812 and supports a second mode profile 814. Lens fiber 830 includes a lens 834 and supports a mode profile 832 at a distal end. Unlike optical fiber assembly 200, optical fiber assembly 800 includes an intermediate fiber 850 similar to intermediate fiber 550 of optical fiber assembly 500 disposed between signal fiber 810 and lens fiber 830. Unlike intermediate fiber 550 of optical fiber assembly 500, intermediate fiber 850 includes a proximal portion 856 that supports a first mode profile substantially similar to mode profile 814 and a distal portion 858 that supports a second mode profile 854 at a distal end. In this aspect, intermediate fiber 850 can be similar to signal fiber 810 and signal fibers 110, 210 of optical fiber assemblies 100, 200.

Intermediate fiber 850 can include a waveguide structure (not shown) defining a core (not shown), and includes a proximal portion 856 that supports a first mode profile substantially similar to mode profile 814, and a distal portion 858 that supports a second mode profile 854 at the distal end. In some embodiments, intermediate fiber 850 can have a substantially constant outer diameter D₄. The waveguide structure of distal portion 858 of intermediate fiber 850 is altered, such as, for example, by applying heat to distal portion 858 of intermediate fiber 850, such that the waveguide structure of distal portion 858 of intermediate fiber 850 is altered. The waveguide structure can be altered prior to fusing/splicing with signal fiber 810 and to lens fiber 830, and/or can be altered after fusing/splicing with signal fiber 810 and to lens fiber 830. In such embodiments, first mode profile (not shown) can be different from second mode profile 854. The first mode profile includes a constant mode profile representing that the mode field diameter of the signal is constant through first portion 856 of intermediate fiber 850, and second mode profile 854 is an expanded mode profile representing that the mode field diameter of a signal increases along distal portion 858 of intermediate fiber 850.

Distal portion 858 of intermediate fiber 850 includes a mode expansion region. The length of the mode expansion region can vary. In some embodiments, the length of the mode expansion region can be about one millimeter. In other embodiments, the length of the mode expansion region can be between about 100 microns and about ten millimeters. The mode expansion region can expand the mode field diameter for an amount between about ten percent expansion and about 400 percent expansion. The amount of expansion of the mode field diameter through the mode expansion region can be based on the length of the mode expansion region, characteristics of the waveguide structure of the intermediate fiber 850, how the distal portion of the signal fiber was altered, the substantially constant outer diameter D₄ of intermediate fiber 850, and/or combinations of the above.

A signal traveling through optical fiber assembly 800 can have a first mode field diameter in a proximal portion 816 of signal fiber 810, represented by first mode profile 812. The signal can have a mode field diameter expanding from the first mode field diameter to a second mode field diameter in distal portion 818 of signal fiber 810, represented by second mode profile 814. The signal can include a substantially constant third mode field diameter in a proximal portion 856 of intermediate fiber 850, represented by first mode profile 814. The signal can have a mode field diameter expanding from the third mode field diameter to a fourth mode field diameter in distal portion 858 of intermediate fiber 850, represented by second mode profile 854. The signal can have a mode field diameter expanding from the fourth mode field diameter to a fifth mode field diameter in lens fiber 830, represented by mode profile 832. Lens 834 can collimate the signal into a collimated beam propagating in free space with a substantially constant outer diameter D₃.

In some embodiments, any of optical fiber assemblies 100-800 can be built into a connector assembly (not shown), for example, a housing configured to mechanically align the optical fiber assembly within a standardized connection, and/or to another of optical fiber assemblies 100-800. In such embodiments, the signal fiber, intermediate fiber, tapered fiber, and/or lens fiber can be secured by, for example, a ferrule, such that inserting the ferrule into a matching connection can mechanically align the optical fiber assembly.

While various embodiments have been described above, it should be understood that they have been presented by way of example only, not limitation, and various changes in form and details may be made. For example, while FIG. 3 depicts an optical fiber assembly 200 transmitting a collimated beam through free space to an optical fiber assembly 200′, in some embodiments, any of optical fiber assemblies 100-800 can transmit a collimated beam to, and/or receive a collimated beam from, any of optical fiber assemblies 100-800. By way of another example, any of optical fiber assemblies 100-800 can include tapered fibers and/or intermediate fibers, and can include multiple tapered fibers and/or intermediate fibers. Rather than collimate an output free space beam the curvature of the lens on any the optical fiber assemblies 100-800 may be modified to cause the propagating free space beam to focus or diverge.

Where methods described above indicate certain events occurring in certain order, the ordering of certain events can be modified. Additionally, certain of the events can be performed concurrently in a parallel process when possible, as well as performed sequentially as described above. Any portion of the apparatus and/or methods described herein may be combined in any combination, except mutually exclusive combinations. The embodiments described herein can include various combinations and/or sub-combinations of the functions, components and/or features of the different embodiments described. Furthermore, values for various dimensions and/or wavelengths are given for exemplary purposes only. For example, while a signal can be described as being centered about a visible wavelength, for example, between centered about 630 nm, signals can be centered about other wavelengths.

What is claimed is:

1. An optical fiber assembly apparatus, comprising:
a signal fiber having a substantially constant outer diameter, a proximal portion, and a distal portion,
the proximal portion having a waveguide structure configured to propagate an optical signal having a first mode field diameter,
the distal portion having an expanded waveguide structure configured to propagate the optical signal having the first mode field diameter at a proximal end of the distal portion and propagate the optical signal having a second mode field diameter at a distal end of the distal portion,
a lens fiber having a proximal end,
the proximal end of the lens fiber being fused to the distal end of the distal portion of the signal fiber,
the lens fiber being configured to propagate the optical signal through a nominally homogenous region.

2. The apparatus of claim 1, wherein the lens fiber has a substantially constant outer diameter.

3. The apparatus of claim 1, wherein the substantially constant outer diameter of the lens fiber is larger than the substantially constant outer diameter of the signal fiber.

4. The apparatus of claim 1, wherein the distal end of the lens fiber includes a lens.

5. The apparatus of claim 4, wherein the lens is configured to collimate the optical signal.

6. The apparatus of claim 1, wherein proximal portion of the signal fiber is monolithically formed with the distal portion of the signal fiber.

7. The apparatus of claim 1, wherein the expanded waveguide structure is configured such that the mode field diameter of the optical signal adiabatically tapers from the first mode field diameter to the second mode field diameter.

8. An apparatus, comprising:
an optical fiber assembly including a signal fiber having a substantially constant outer diameter, the signal fiber having a mode expansion region, the mode expansion region configured to expand a mode field diameter of a signal from a first mode field diameter to a second mode field diameter,
the optical fiber assembly including an intermediate optical fiber, a proximal end of the intermediate optical fiber having a first outer diameter and being fused to a distal end of the signal fiber, and a distal end of the intermediate optical fiber having a second outer diameter,
the optical fiber assembly including a lens fiber having a substantially constant outer diameter, and being fused to the distal end of the intermediate optical fiber.

9. An apparatus of claim 8, where the intermediate optical fiber is tapered.

10. The apparatus of claim 8, wherein the outer diameter of the signal fiber is substantially the same as the first outer diameter of the intermediate optical fiber.

11. The apparatus of claim 8, wherein second outer diameter of the intermediate optical fiber is substantially the same as the substantially constant outer diameter of the lens fiber.

12. An apparatus of claim 8, where the intermediate optical fiber has a substantially constant outer diameter.

13. The apparatus of claim 8, wherein the intermediate optical fiber is configured to expand the mode field diameter of the optical signal from the second mode field diameter at the proximal end of the intermediate optical fiber to a third mode field diameter at the distal end of the intermediate optical fiber.

14. The apparatus of claim 8, wherein the lens fiber has a lens configured to collimate an optical signal.

15. The apparatus of claim 8, wherein the mode expansion region is configured such that the mode field diameter of the optical signal adiabatically tapers from the first mode field diameter to the second mode field diameter.

16. A method, comprising:
heating a distal portion of a signal fiber to define a mode expansion region configured to expand a mode field diameter of an optical signal from a first mode field diameter to a second mode field diameter; and
fusing a proximal end of a lens fiber to a distal end of the signal fiber.

17. The method of claim 16, wherein the lens fiber is configured to propagate the optical signal through a nominally homogenous region.

18. The method of claim 16, wherein the fusing the proximal end of the lens fiber to the distal end of the signal fiber is performed prior to heating the distal portion of the signal fiber to define the mode expansion region.

19. The method of claim 16, wherein the heating the distal portion of the signal fiber to define the mode expansion region is performed prior to fusing the proximal end of the lens fiber to the distal end of the distal portion of the signal fiber.

20. The method of claim 16, wherein the signal fiber and the lens fiber produce a optical fiber assembly when the lens fiber is fused to the signal fiber,
the method further comprising forming a lens at the distal end of the lens fiber.

21. The method of claim 20 wherein the lens is configured to collimate an optical signal.

22. The method of claim 16, wherein the lens fiber has a substantially constant outer diameter less than three times as large as a substantially constant outer diameter of the signal fiber.

23. The method of claim 16, wherein the signal fiber includes a proximal portion, the proximal portion of the signal fiber being monolithically formed with the distal portion of the signal fiber.
